(19) United States
(12) Patent Application Publication
(10) Pub. No.: US 2010/0050364 A1
(43) Pub. Date: Mar. 4, 2010

(54) Washing device

(75) Inventors: Tae Young Oh, Gyeonggi-do (KR); Hui Jae Lee, Daejeon-si (KR); Geon Yong Kim, Gyeonggi-do (KR); Eun Ha Lee, Gyeonggi-do (KR)

Correspondence Address: MORGAN LEWIS & BOCKIUS LLP, 1111 PENNSYLVANIA AVENUE NW, WASHINGTON, DC, 20004, US

(73) Assignee: LG Display Co., Ltd.

(21) Appl. No.: 12/314,962

(22) Filed: Dec. 19, 2008

(30) Foreign Application Priority Data
Sep. 4, 2008 (KR) P 2008-87119

(51) Int. Cl. B08B 5/02

(52) U.S. Cl. 15/300.1; 15/4

(57) ABSTRACT

A washing device capable of stably washing a substrate is disclosed. The washing device includes a substrate entry guiding unit which guides a substrate supplied from the outside to be entered in a correct direction, a dirt removing unit supplied with the substrate from the substrate entry guiding unit to remove dirt formed on the substrate, a dirt washing unit supplied with the substrate from the dirt removing unit to wash off residual dirt remaining on the substrate, and a position controlling unit controlling position of the substrate being discharged from the dirt washing unit.

This application claims the benefit of the Korean Patent Application No. 10-2008-87119, filed on Sep. 4, 2008, which is hereby incorporated by reference as if fully set forth herein.

### BACKGROUND OF THE INVENTION

1. Field of the Invention

The present invention relates to a washing device, and more particularly, to a washing device capable of washing a substrate more safely.

2. Discussion of the Related Art

Generally, LCD devices display an image by adjusting optical transmittance of liquid crystal cells in accordance with video signals. Active matrix LCD devices are advantageous especially in displaying a moving picture since having a switching element at each pixel cell. A thin film transistor (TFT) is generally used for the switching element.

The LCD device comprises a pair of substrates facing each other, and a liquid crystal layer interposed between the substrates. One of the substrates is equipped with TFTs such as the switching device while the other one is equipped with a color filter. Before and after the above processes, a washing process is performed with respect to the respective substrates.

Conventionally, a brush or a belt has been used for the washing process, which removes dirt or foreign substances from the substrates by physically contacting the substrates. However, such direct contact between the washing tool and the substrate may damage the substrate.

Moreover, since the washing process has been performed only once, dirt may not be perfectly removed.

### SUMMARY OF THE INVENTION

Accordingly, the present invention is directed to a washing device that substantially obviates one or more problems due to limitations and disadvantages of the related art.

An object of the present invention is to provide a washing device capable of preventing damage of a substrate by applying an impact only to dirt rather than physically impacting the substrate, and improving the washing efficiency by increasing the washing processes to at least two steps.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a washing device comprises a substrate entry guiding unit which guides a substrate supplied from the outside to be entered in a correct direction; a dirt removing unit supplied with the substrate from the substrate entry guiding unit to remove dirt formed on the substrate; a dirt washing unit supplied with the substrate from the dirt removing unit to wash off residual dirt remaining on the substrate; and a position controlling unit controlling position of the substrate being discharged from the dirt washing unit.

The substrate entry guiding unit may include an entry guide path which guides the substrate being supplied from the outside to be correctly entered in the dirt removing unit. The entry guide path is narrowed in width from the outside toward the dirt removing unit.

The substrate entry guiding unit may comprise an upper structure and a lower structure facing each other at a predetermined distance to form the entry guide path therebetween. Here, the upper structure jets air toward the entry guide path and draws the jetted air and the lower structure also jets air to the entry guide path and draws the jetted air, thereby maintaining the substrate entered in the entry guide path in a floating state. One of facing surfaces each of the upper structure and the lower structure may be an inclined surface of the upper structure, which is inclined with respect to an upper surface of the substrate, while the other one of facing surfaces each of the upper and the lower structures is an inclined surface of the lower structure, which is inclined with respect to a lower surface of the substrate. The entry guide path is formed in a space between the inclined surfaces.

The upper and the lower structures may be made of a porous material such that the air from the outside can be jetted penetrating the upper and the lower structures.

The upper and the lower structures may each include a plurality of suction holes to draw the air, the suction holes of the upper structure formed through the upper structure and directed to the entry guide path, and the suction holes of the lower structure formed through the lower structure and directed to the entry guide path.

The dirt removing unit may comprise an upper dirt removing unit and a lower dirt removing unit facing each other at a predetermined distance to form a moving space for passage of the substrate. The upper dirt removing unit removes the dirt formed on an upper surface of the substrate through a physical contact, and the lower dirt removing unit removes the dirt formed on a lower surface of the substrate through a physical contact.

The upper and the lower dirt removing units may be made of metal.

The upper and the lower dirt removing units may each include a main body and a removal part formed on an outer surface of the main body. Here, the main body is formed of a porous material so that the air supplied from the outside can be passed through the main body and jetted to the substrate. The removal part is formed on outer surfaces of the main body except an air supplied surface and an air jetted surface, and is made of metal. The main body of the upper dirt removing unit includes a plurality of suction holes to draw the air from the upper surface of the substrate, and the main body of the lower dirt removing unit includes a plurality of suction holes to draw the air from the lower surface of the substrate.

The upper and the lower dirt removing units may be oscillated.

More specifically, the upper dirt removing unit may move in an up and down direction with respect to the upper surface of the substrate within a range not contacting the upper surface, and the lower dirt removing unit may move in an up and down direction with respect to the lower surface of the substrate within a range not contacting the lower surface.

The upper dirt removing unit repeatedly may move in a forward and backward direction or in a lateral direction to be parallel with the upper surface of the substrate, and the lower dirt removing unit repeatedly may move in a forward and backward direction or in a lateral direction to be parallel with the lower surface of the substrate.

The dirt washing unit may comprise an upper dirt washing unit and a lower dirt washing unit which are facing each other at a predetermined gap and thereby forming a moving space for passage of the substrate. The upper dirt washing unit jets air toward the moving space and draws in the jetted air, and the lower dirt washing, unit jets air toward the moving space and draws in the jetted air. The upper dirt washing unit jets a washing agent toward the moving space and generates foam with the jetted washing agent and air, thereby removing the dirt formed on the upper surface of the substrate passing through the moving space. The lower dirt washing unit jets a washing agent toward the moving space and generates foam, thereby removing the dirt formed on the lower surface of the substrate passing through the moving space. The upper and the lower dirt washing units discharge the washing agent to the outside using the drawn air.

The upper and the lower dirt washing units may be made of a porous material such that the outside air can be jetted to the moving space penetrating the upper and lower dirt washing units.

The upper and the lower dirt washing units may each include a plurality of suction holes which draw the air and a plurality of jetting holes which jet the washing agent. The suction holes of the upper dirt washing unit are formed penetrating the upper dirt washing unit and directed to the moving space, and the suction holes of the lower dirt washing unit are directed to the moving space, penetrating the lower dirt washing unit.

The upper dirt washing unit may further comprise a plurality of trenches. The plurality of suction holes are connected to any one of the trenches to draw the air or the washing agent through the trench, and the plurality of jetting holes are connected to another one of the trenches to jet the washing agent through the trench.

The position controlling unit maintains a floating state of the substrate being discharged, by jetting air to a lower surface of the substrate and simultaneously drawing the jetted air.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and along with the description serve to explain the principle of the invention. In the drawings:

FIG. 1 shows a washing device according to an embodiment of the present invention;

FIG. 2 shows an upper dirt removing unit shown in FIG. 1, according to another embodiment of the present invention;

FIG. 3 is a perspective view of a washing unit in FIG. 1;

FIG. 4 is a rear view of the upper dirt washing unit shown in FIG. 3; and

FIG. 5 is a view explaining the principle in that dirt formed on the substrate is removed.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

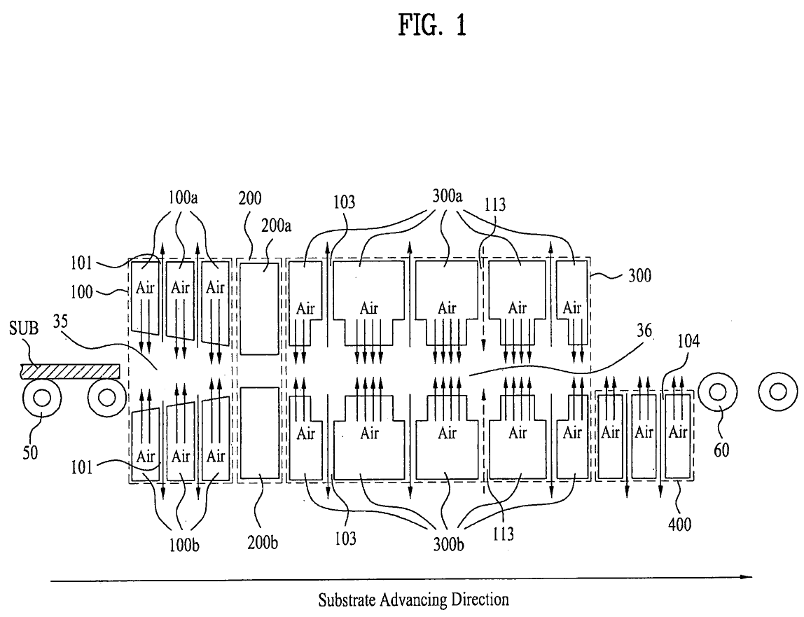

FIG. 1 shows a washing device according to an embodiment of the present invention.

Referring to FIG. 1, the washing device comprises a substrate entry guiding unit 100 guiding a substrate SUB from the outside to be inserted in a correct direction, a dirt removing unit 200 supplied with the substrate SUB from the substrate entry guiding unit 100 to remove dirt formed on the substrate SUB, a dirt washing unit 300 supplied with the substrate SUB from the dirt removing unit 200 to remove dirt remaining on the substrate SUB by washing off the dirt, and a position controlling unit 400 controlling the position of the substrate SUB being unloaded from the dirt washing unit 300.

The respective parts will be described in greater detail below.

Substrate Entry Guiding Unit

The substrate entry guiding unit 100 includes an entry guide path 35 which guides the substrate SUB entering from the outside by a roller to be correctly entered in the dirt removing unit 200. The entry guide path 35 has a gradually narrowing width toward the dirt removing unit 200. By the above shape of the entry guide path 35, the substrate SUB can be automatically directed to the precise center of the entry guide path 35 although being supplied as deviated.

The substrate entry guiding unit 100 comprises an upper structure 100a and a lower structure 100b which are directed to each other keeping a predetermined gap therebetween. The entry guide path 35 is formed in the gap between the upper and lower structures 100a and 100b.

The upper structure 100a jets air toward the entry guide path 35 and also draws in the jetted air. Likewise, the lower structure 100b jets air toward the entry guide path 35 and draws in the jetted air. Accordingly, the substrate SUB that entered the entry guide path 35 is floated in a space of the entry guide path 35. More specifically, while the upper structure 100a jets air to an upper surface of the substrate SUB and draws the jetted air, the lower structure 100b jets air to a lower surface of the substrate SUB and draws the jetted air, thereby maintaining the substrate SUB in a floating state. Here, the jetting force is greater than the drawing force.

Two facing surfaces each of the upper and the lower structures 100a and 100b are inclined by a predetermined angle. Specifically, the inclined surface of the upper structure 100a is inclined with respect to the upper surface of the substrate SUB whereas the inclined surface of the lower structure 100b is inclined with respect to the lower surface of the substrate SUB. The space defined by the two inclined surfaces forms the entry guide path 35. The width of the entry guide path 35 can be varied by adjusting the interval between the upper and the lower structures 100a and 100b.

The upper and the lower structures 100a and 100b are made of a porous material such that the air from the outside can be jetted penetrating the upper and the lower structures 100a and 100b. More specifically, the air jetted from the outside toward the upper surface of the upper structure 100a is supplied to the entry guide path 35 by passing through the upper structure 100a. The outside air jetted to the lower surface of the lower structure 100b is supplied to the entry guide path 35 by passing through the lower structure 100b.

The upper structure 100a and the lower structure 100b each includes a plurality of suction holes 101 for drawing the jetted air. The suction holes 101 of the upper structure 100a are formed penetrating the upper structure 100a and directed to the entry guide path 35. The suction holes 101 of the lower structure 100b are formed penetrating the lower structure 100b and directed to the entry guide path 35.

Dirt Removing Unit

The dirt removing unit 200 comprises an upper dirt removing unit 200a and a lower dirt removing unit 200b facing each other. The upper and lower dirt removing units 200a and 200b are distanced by a predetermined gap, and a moving space 36 is defined by the gap between the two structures 200a and 200b for the substrate SUB to move therethrough.

The upper dirt removing unit 200a removes dirt formed at the upper surface of the substrate SUB by physically contacting the dirt formed on the upper surface of the substrate SUB. The lower dirt removing unit 200b removes dirt formed at the lower surface of the substrate SUB also by physically contacting the dirt formed on the lower surface of the substrate SUB.

When the substrate SUB is disposed in the moving space 36 between the upper and the lower dirt removing units 200a and 200b, an interval between the upper dirt removing unit 200a and the upper surface of the substrate SUB is about 20 μm, and an interval between the lower dirt removing unit 200b and the lower surface of the substrate SUB is also about 20 μm. Thus, since the substrate SUB is in close proximity to the upper and the lower dirt removing units 200a and 200b, as the substrate SUB is moving through the moving space 36, dirt formed on the upper surface of the substrate SUB and protruding upward is removed by collision with the upper dirt removing unit 200a and dirt formed on the lower surface and protruding downward is removed by collision with the lower dirt removing unit 200b. The interval between the upper and the lower dirt removing units 200a and 200b may be varied according to thickness of the substrate SUB.

The upper and the lower dirt removing units 200a and 200b may be formed of metal.

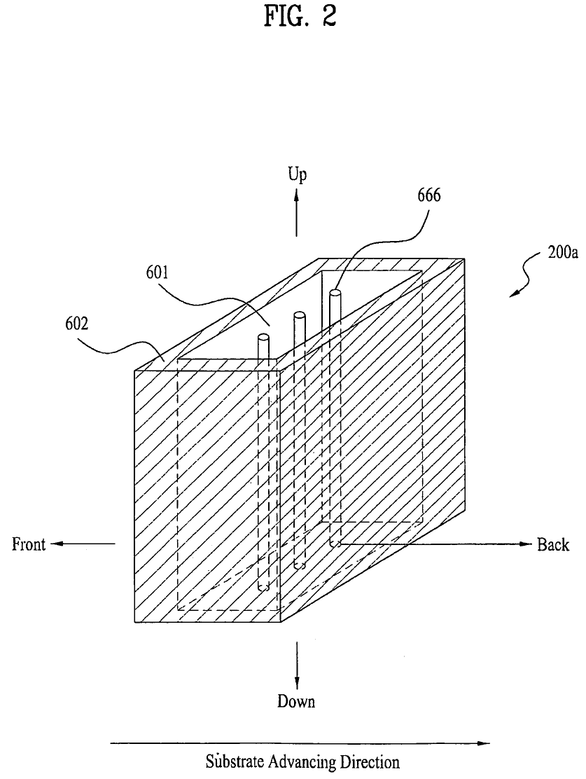

According to another embodiment, the upper and the lower dirt removing units 200a and 200b may be structured in a different manner as illustrated in FIG. 2.

FIG. 2 shows the upper dirt removing unit 200a of FIG. 1 according to another embodiment of the present invention.

Referring to FIG. 2, the upper dirt removing unit 200a includes a main body 601 and a removal part 602 formed on an outside of the main body 601.

The main body 601 is formed of a porous material so that the air supplied from the outside can be passed through the main body 601 and jetted to the substrate SUB. The removal part 602 is formed on outer surfaces of the main body 601 except an air supplied surface and an air jetted surface. Here, the removal part 602 is made of metal, and the main body 601 of the upper dirt removing unit 200a includes a plurality of suction holes 666 to draw the air from the upper surface of the substrate SUB.

Although not shown, the lower dirt removing unit 200b may also be structured in the same manner as the upper dirt removing unit 200a as shown in FIG. 2. In other words, the lower dirt removing unit 200b comprises a main body and a removal part including suction holes.

The suction holes of the upper and lower dirt removing unit maintain the substrate in floating state.

The upper and the lower dirt removing units 200a and 200b are oscillatory, so as to remove the dirt off the substrate SUB more effectively through the oscillation.

As shown in FIG. 2, the upper and the lower dirt removing units 200a and 200b move in an up and down direction. The upper dirt removing unit 200a moves up and down with respect to the upper surface of the substrate SUB within a range not to contact the upper surface of the substrate SUB. Also, the lower dirt removing unit 200b moves up and down with respect to the lower surface within a range not to contact the lower surface of the substrate SUB.

In addition, the upper dirt removing unit 200a may repeatedly move in a forward and backward direction or in a lateral direction to be parallel with the upper surface of the substrate SUB. Also, the lower dirt removing unit 200b may repeatedly move in a forward and backward direction, or in a lateral direction to be parallel with the lower surface of the substrate SUB.

Dirt Washing Unit

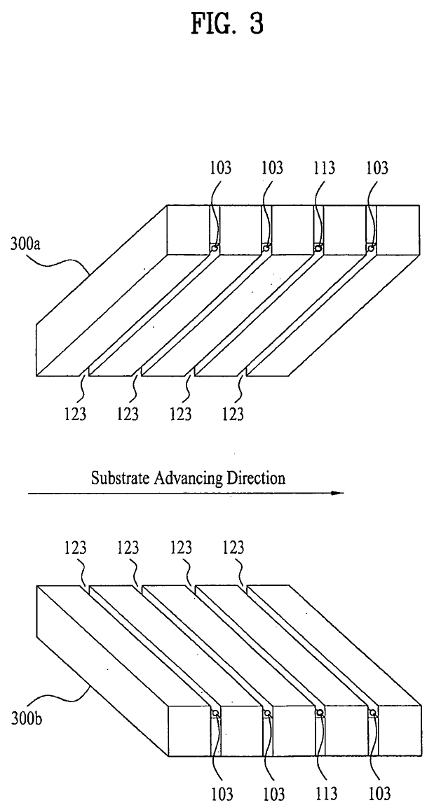

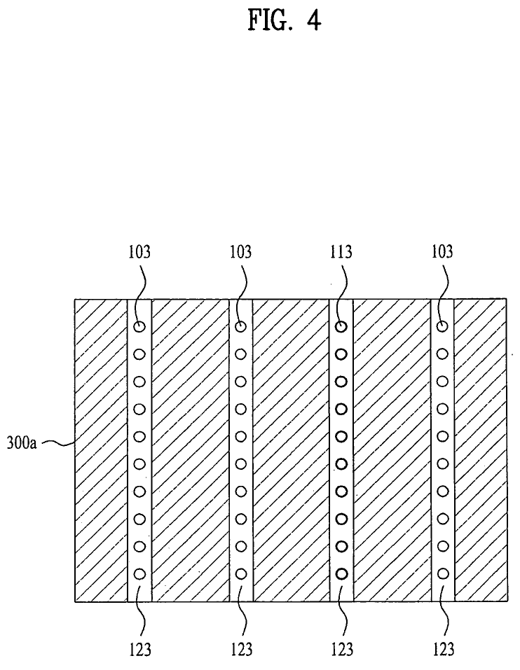

FIG. 3 is a perspective view of a washing unit in FIG. 1, and FIG. 4 is a rear view of the upper dirt washing unit shown in FIG. 3.

Referring to FIGS. 1, 3 and 4, the dirt washing unit 300 comprises upper and lower dirt washing units 300a and 300b which are facing each other, keeping a predetermined gap therebetween. The moving space 36 is formed in the gap between the two structures 300a and 300b for the substrate SUB to move therethrough.

The upper dirt washing unit 300a jets air toward the moving space 36 and also draws in the jetted air. Likewise, the lower dirt washing unit 300b jets air toward the moving space 36 and draws in the jetted air. Accordingly, the substrate SUB that entered the moving space 36 is floated in a space of the moving space 36. More specifically, while the upper dirt washing unit 300a jets air to the upper surface of the substrate SUB and draws the jetted air, the lower dirt washing unit 300b jets air to the lower surface of the substrate SUB and draws the jetted air, thereby maintaining the substrate SUB in a floating state. Here, the jetting force is greater than the drawing force.

The upper dirt washing unit 300a jets a washing agent toward the moving space 36 and generates foam with the jetted washing agent and air, thereby removing the dirt formed on the upper surface of the substrate SUB passing through the moving space 36. The lower dirt washing unit 300b jets a washing agent toward the moving space 36 and generates foam, thereby removing the dirt formed on the lower surface of the substrate SUB passing through the moving space 36. Furthermore, the upper and the lower dirt washing units 300a and 300b discharge the washing agent to the outside using the drawn air. A deionized water may be adopted for the washing agent.

The upper and the lower dirt washing units 300a and 300b are made of a porous material such that the outside air can be jetted to the moving space 36 penetrating the upper and lower dirt washing units 300a and 300b. More specifically, the air jetted from the outside toward the upper surface of the upper dirt washing unit 300a is supplied to the moving space 36 by passing through the upper dirt washing unit 300a. The outside air jetted to the lower surface of the lower dirt washing unit 300b is supplied to the moving space 36 by passing through the lower dirt washing unit 300b.

The upper dirt washing unit 300a and the lower dirt washing unit 300b each includes a plurality of suction holes 103 for drawing the air. The suction holes 103 of the upper dirt washing unit 300a are formed penetrating the upper dirt washing unit 300a and directed to the moving space 36. The suction holes 103 of the lower dirt washing unit 300b are directed to the moving space 36, penetrating the lower dirt washing unit 300b.

The upper dirt washing unit 300a further comprises a plurality of jetting holes 113 and a plurality of trenches 123. The plurality of suction holes 103 are connected to any one of the trenches 123 to draw the air or the washing agent through the trench 123. In addition, the plurality of jetting holes 113 are connected to another one of the trenches 123 to jet the washing agent through the another trench 123.

Each of the trenches 123 has a length in a vertical direction to an advancing direction of the substrate SUB. The trenches 123 are arranged along the advancing direction of the substrate SUB. By filling the trenches 123 with the washing agent, the washing efficiency for the substrate SUB can be enhanced.

An interval between the upper dirt washing unit 300a and the upper surface of the substrate SUB is about 20 μM, and an interval between the lower dirt washing unit 300b and the lower surface of the substrate SUB is also about 20 μM. The interval between the upper and the lower dirt washing units 300a and 300b may be varied according to thickness of the substrate SUB.

Position Controlling Unit

The position controlling unit 400 jets the air toward the lower surface of the substrate SUB being unloaded and simultaneously draws the jetted air, thereby maintaining the floating state of the substrate SUB. The substrate SUB is moved through a roller 60 from the position controlling unit 400 to a next processing equipment.

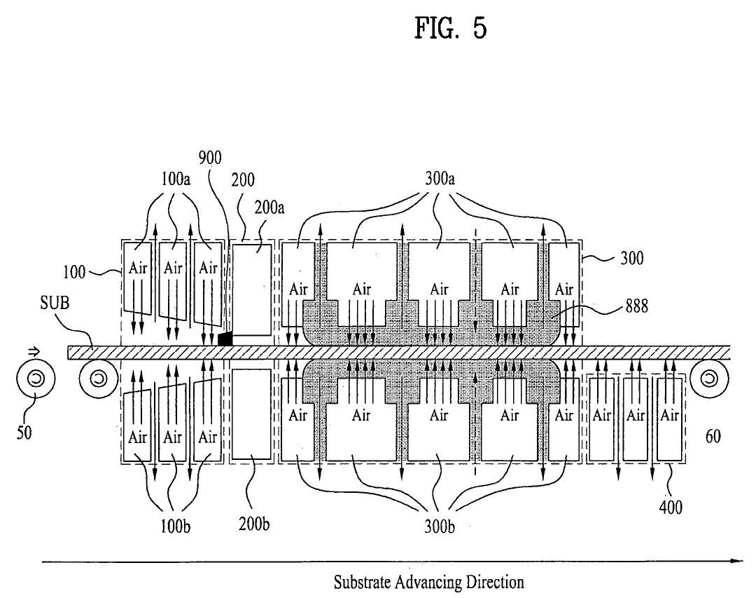

FIG. 5 is a view explaining the principle in that dirt formed on the substrate is removed.

As shown in FIG. 5, the dirt 900 is formed on the upper surface of the substrate SUB. Such adherent dirt 900 can be removed through a physical contact with the upper dirt removing unit 200a. Residual dirt still remaining after the operation of the upper dirt removing unit 200a or clotted dirt irremovable by the upper dirt removing unit 200a is further removed by the dirt washing unit 300. That is, the residual dirt and the clotted dirt are removed by the washing agent 888 jetted by the dirt washing unit 300 and the foam generated by jetting the air to the washing agent 888.

As apparent from the above description, the washing device according to an embodiment of the present invention has the following advantages.

First, the substrate can be protected from damage since an impact is applied only to dirt on the substrate.

Second, the washing efficiency is enhanced by increasing the number of washing processes to at least two steps.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A washing device comprising:
a substrate entry guiding unit which guides a substrate supplied from the outside to be entered in a correct direction;
a dirt removing unit supplied with the substrate from the substrate entry guiding unit to remove dirt formed on the substrate;
a dirt washing unit supplied with the substrate from the dirt removing unit to wash off residual dirt remaining on the substrate; and
a position controlling unit controlling position of the substrate being unloaded from the dirt washing unit.

2. The washing device according to claim 1, wherein
the substrate entry guiding unit includes an entry guide path which guides the substrate being supplied from the outside to be correctly entered in the dirt removing unit, and
the entry guide path is narrowed in width from the outside toward the dirt removing unit.

3. The washing device according to claim 2, wherein the substrate entry guiding unit comprises an upper structure and a lower structure facing each other at a predetermined distance to form the entry guide path therebetween,
the upper structure jets air toward the entry guide path and draws the jetted air and the lower structure also jets air to the entry guide path and draws the jetted air, thereby maintaining the substrate entered in the entry guide path in a floating state,
one of facing surfaces each of the upper structure and the lower structure is an inclined surface of the upper structure, which is inclined with respect to an upper surface of the substrate,
the other one of facing surfaces each of the upper and the lower structures is an inclined surface of the lower structure, which is inclined with respect to a lower surface of the substrate, and
the entry guide path is formed in a space between the inclined surfaces.

4. The washing device according to claim 3, wherein the upper and the lower structures are made of a porous material such that the air from the outside can be jetted penetrating the upper and the lower structures.

5. The washing device according to claim 4, wherein the upper and the lower structures each includes a plurality of suction holes to draw the air,
the suction holes of the upper structure are formed through the upper structure and directed to the entry guide path, and
the suction holes of the lower structure are formed through the lower structure and directed to the entry guide path.

6. The washing device according to claim 1, wherein
the dirt removing unit comprises an upper dirt removing unit and a lower dirt removing unit facing each other at a predetermined distance to form a moving space for passage of the substrate,
the upper dirt removing unit removes the dirt formed on an upper surface of the substrate through a physical contact, and
the lower dirt removing unit removes the dirt formed on a lower surface of the substrate through a physical contact.

7. The washing device according to claim 6, wherein the upper and the lower dirt removing units are made of metal.

8. The washing device according to claim 6, wherein
the upper and the lower dirt removing units each include a main body and a removal part formed on an outer surface of the main body,
the main body is formed of a porous material so that the air supplied from the outside can be passed through the main body and jetted to the substrate,
the removal part is formed on outer surfaces of the main body except an air supplied surface and an air jetted surface, the removal part is made of metal,
the main body of the upper dirt removing unit includes a plurality of suction holes to draw the air from the upper surface of the substrate, and
the main body of the lower dirt removing unit includes a plurality of suction holes to draw the air from the lower surface of the substrate.

9. The washing device according to claim 6, wherein the upper and the lower dirt removing units are oscillatory.

10. The washing device according to claim 9, wherein
the upper dirt removing unit moves in an up and down direction with respect to the upper surface of the substrate within a range not contacting the upper surface, and
the lower dirt removing unit moves in an up and down direction with respect to the lower surface of the substrate within a range not contacting the lower surface.

11. The washing device according to claim 9, wherein
the upper dirt removing unit repeatedly moves in a forward and backward direction or in a lateral direction to be parallel with the upper surface of the substrate, and
the lower dirt removing unit repeatedly moves in a forward and backward direction or in a lateral direction to be parallel with the lower surface of the substrate.

12. The washing device according to claim 1, wherein
the dirt washing unit comprises an upper dirt washing unit and a lower dirt washing unit which are facing each other at a predetermined gap and thereby forming a moving space for passage of the substrate,
the upper dirt washing unit jets air toward the moving space and also draws in the jetted air and the lower dirt washing unit jets air toward the moving space and draws in the jetted air,
the upper dirt washing unit jets a washing agent toward the moving space and generates foam with the jetted washing agent and air, thereby removing the dirt formed on the upper surface of the substrate passing through the moving space,
the lower dirt washing unit jets a washing agent toward the moving space and generates foam, thereby removing the dirt formed on the lower surface of the substrate passing through the moving space, and
the upper and the lower dirt washing units discharge the washing agent to the outside using the drawn air.

13. The washing device according to claim 12, wherein the upper and the lower dirt washing units are made of a porous material such that the outside air can be jetted to the moving space penetrating the upper and lower dirt washing units.

14. The washing device according to claim 13, wherein
the upper and the lower dirt washing units each includes a plurality of suction holes which draw the air and a plurality of jetting holes which jet the washing agent,
the suction holes of the upper dirt washing unit are formed penetrating the upper dirt washing unit and directed to the moving space, and
the suction holes of the lower dirt washing unit are directed to the moving space, penetrating the lower dirt washing unit.

15. The washing device according to claim 14, wherein
the upper dirt washing unit further comprises a plurality of trenches,
the plurality of suction holes are connected to any one of the trenches to draw the air or the washing agent through the trench, and
the plurality of jetting holes are connected to another one of the trenches to jet the washing agent through the trench.

16. The washing device according to claim 1, wherein the position controlling unit maintains a floating state of the substrate being unloaded, by jetting air to a lower surface of the substrate and simultaneously drawing the jetted air.
